(19) United States
(12) Patent Application Publication
(10) Pub. No.: US 2017/0307859 A1
(43) Pub. Date: Oct. 26, 2017

(54) 3D PRINTER, 3D PRINTING METHOD AND LENS MODULE

(71) Applicant: HAN'S LASER TECHNOLOGY INDUSTRY GROUP CO., LTD., Shenzhen (CN)

(72) Inventors: Jiaying LI, Shenzhen (CN); Chaoming ZHOU, Shenzhen (CN); Bo SUN, Shenzhen (CN); Yuqing CHEN, Shenzhen (CN); Yunfeng GAO, Shenzhen (CN)

(73) Assignee: HAN'S LASER TECHNOLOGY INDUSTRY GROUP CO., LTD., Shenzhen (CN)

(21) Appl. No.: 15/517,941

(22) PCT Filed: Dec. 3, 2014
(86) PCT No.: PCT/CN2014/092963

§ 371 Date: Apr. 7, 2017

(51) Int. Cl. G02B 13/18; B23K 26/06

(52) U.S. Cl. CPC G02B 13/18; B23K 26/06

(57) ABSTRACT

A lens module, comprising a first lens, a second lens and a third lens sequentially and coaxially arranged in the transmission direction of incident light. The first lens is a biconcave lens, the second lens is a meniscus lens, and the third lens is a biconvex lens. The first lens comprises a first curved surface and a second curved surface. The second lens comprises a third curved surface and a fourth curved surface. The third lens comprises a fifth curved surface and a sixth curved surface. The first to the sixth curved surfaces are sequentially arranged in the transmission of the incident light, and the curvature radii of the first to the sixth curved surfaces are sequentially −37±5%, 400±5%, −130±5%, −60±5%, 360±5%, and −68±5%, in a unit of millimeter. Due to the arrangement and parameter design of the first to the third lenses of the lens module, the 3D printer can achieve high machining precision. The present invention also provides a 3D printer and a 3D printing method thereof.

### FIELD OF THE INVENTION

The present disclosure relates to the field of a laser processing system, and more particularly relates to a 3D printer, a 3D printing method, and a lens module.

### BACKGROUND OF THE INVENTION

In recent years, the development of 3D printer has become very rapid. The term 3D printing's origin sense is in reference to a process that deposits a binder material onto a powder bed with inkjet printer heads layer by layer, and three-dimensional objects are produced using digital model data from a 3D model. However, due to the design of the printing method and the lens module, the 3D printer has a poor machining precision and cannot be used to process the part which needs fine processing.

### SUMMARY

Therefore, it is necessary to provide a 3D printer, a printing method, and a lens module with high machining precision.

A lens module includes a first lens, a second lens, and a third lens, which are sequentially and coaxially arranged along a transmission direction of incident light, wherein the first lens is a biconcave lens, the second lens is a meniscus lens, and the third lens is a biconvex lens, the first lens has a first curved surface and a second curved surface, the second lens has a third curved surface and a fourth curved surface, the third lens has a fifth curved surface and a sixth curved surface, the first curved surface to the sixth curved surface are sequentially arranged along the transmission of the incident light, and the curvature radii of the first curved surface to the sixth curved surface are −37±5%, 400±5%, −130±5%, −60±5%, 360±5%, and −68±5%, respectively in a unit of millimeter.

In one embodiment, central thicknesses of the first lens to the third lens are 7±5%, 5±5%, and 13±5%, respectively in a unit of millimeter.

In one embodiment, the first lens has a ratio of refractive index to Abbe number of (1.5/64)±5%, the second lens has a ratio of refractive index to Abbe number of (1.67/32)±5%, and the third lens has a ratio of refractive index to Abbe number of (1.67/32)±5%.

In one embodiment, the lens module further includes a fourth lens disposed behind the third lens along the transmission direction of the incident light, and the fourth lens is a planar lens.

In one embodiment, the fourth lens is a protective glass, which has a central thickness of 3±5% mm, and a ratio of refractive index to Abbe number of (1.5/64)±5%.

In one embodiment, the lens module has a focal length of 160 mm, an entrance pupil diameter of 12 mm, and an operating wavelength of 1060 nm.

A 3D printer includes a laser, a beam expander, a first galvanometer, a second galvanometer, and a lens module above, which are sequentially arranged along a transmission direction of incident light, wherein the laser, the beam expander, and the first galvanometer are collinearly arranged, the second galvanometer is parallel with the first galvanometer, wherein the 3D printer further includes an orienting bracket located adjacent to the lens module, and a support member slidably mounted on the orienting bracket, the second galvanometer, the lens module and the support member are sequentially and collinearly arranged.

A 3D printing method includes the following steps of:

providing a 3D printer described above;

positioning a workpiece to be processed on a support member of the 3D printer; and

radiating, by a laser, a laser beam, which goes through a beam expander, a first galvanometer, a second galvanometer, and a lens module to reach the workpiece to be processed, and engraving the workpiece to be processed.

In one embodiment, during engraving of the workpiece to be processed by the laser beam, the first galvanometer and the second galvanometer rotate to deflect the laser beam, the support member drives the workpiece to be processed to move to cooperate with deflecting of the laser beam, so as to achieve an overall engraving of the workpiece to be processed.

Due to the arrangement and parameter design of the first lens to the third lens of the lens module, the 3D printer exhibits high machining accuracy.

### BRIEF DESCRIPTION OF THE DRAWINGS

The above objects, features and advantages of the present disclosure will become more apparent by describing in detail embodiments thereof with reference to the accompanying drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic diagram of a 3D printer according to an embodiment;

FIG. 2 is a schematic diagram of a lens module of the 3D printer of FIG. 1;

FIG. 3 is a graphic diagram showing aberration of the lens module of FIG. 2;

FIG. 4 is a graphic diagram showing modulation transfer function M.T.F of the lens module of FIG. 2;

FIG. 5 is a graphic diagram showing stigmatism of the lens module of FIG. 2;

FIG. 6 is a graphic diagram showing distortion of the lens module of FIG. 2; and

FIG. 7 is a flowchart of a printing method according to an embodiment.

### DETAILED DESCRIPTION OF THE EMBODIMENTS

In order to make the above objects, features and advantages of the present disclosure become more apparent, the specific embodiments will be described in detail in combination with the accompanying drawings. Numerous specific details are described hereinafter in order to facilitate a thorough understanding of the present disclosure. The various embodiments of the disclosure may, however, be embodied in many different forms and should not be construed as limited to the specific embodiments set forth hereinafter, and people skilled in the art can make similar modifications without departing from the spirit of the present disclosure.

It should be noted that in the specification, the propagation direction of the light is from the left side to the right side of the drawing. The positive or negative curvature radius of the lens is determined by taking a relative positional relationship between an intersection point of the curved surface and the principal optical axis and a center of the spherical surface of the curved surface. If the center of the spherical surface is in the left of the intersection point, the radius of curvature has a negative value, if, on the other hand, the center of the spherical surface is in the right of the intersection point, the radius of curvature has a positive value. In addition, the left side of the lens is an object side, and the right side of the lens is an image side. A positive lens refers that the central thickness of which is larger than the thickness of the edge, and a negative lens refers that the central thickness of which is smaller than the thickness of the edge.

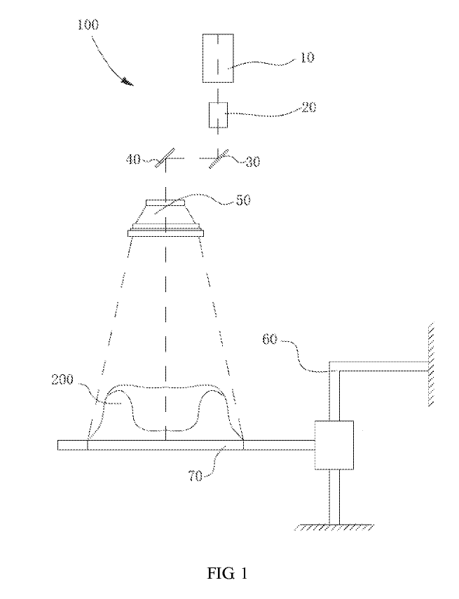

Referring to FIG. 1, a 3D printer 100 according to an embodiment includes a laser 10, a beam expander 20, a first galvanometer 30, a second galvanometer 40, and a lens module 50, which are sequentially arranged along a transmission direction of light. The 3D printer 100 further includes an orienting bracket 60 disposed adjacent to the lens module 50, and a support member 70 slidably mounted on the orienting bracket 60. The laser 10, the beam expander 20, and the first galvanometer 30 are collinearly arranged, the second galvanometer 40 is parallel with the first galvanometer 30. The second galvanometer 40, the lens module 50 and the support member 70 are sequentially and collinearly arranged, and the support member 70 is positioned below the lens module 50. In the illustrated embodiment, the support member 70 is shaped as a flat plate carrying a workpiece 200 to be processed. The first galvanometer 30 is an X galvanometer, and the second galvanometer 40 is a Y galvanometer.

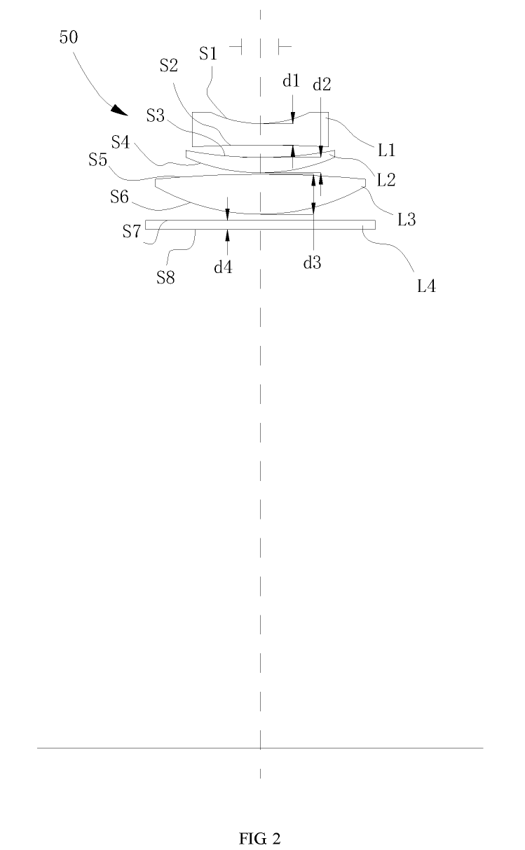

Referring to FIG. 2, the lens module 50 includes a first lens L1, a second lens L2, a third lens L3 and a fourth lens L4, which are sequentially and coaxially arranged along the transmission direction of the incident light. The first lens L1 is a biconcave lens, the second lens L2 is a meniscus lens, the third lens L3 is a biconvex lens, and the fourth lens L4 is a planar lens. The first lens L1 has a first curved surface S1 and a second curved surface S2; the second lens L2 has a third curved surface S3 and a fourth curved surface S4; the third lens L3 has a fifth curved surface S5 and a sixth curved surface S6; and the fourth lens L4 has a seventh curved surface S7 and a eighth curved surface S8. The two curved surfaces of each lens serve as a light incident surface and a light outgoing surface, respectively. The first curved surface S1 to the eighth curved surface S8 are sequentially arranged along the transmission of the incident light. The first curved surface S1, the third curved surface S3, the fourth curved surface S4, and the sixth curved surface S6 have a same bending direction, which are convex surfaces along the incident light (i.e. facing the image side). The second curved surface S2 and the fifth curved surface S5 have a same bending direction, which are convex surfaces facing the incident light (i.e. facing the object side). The seventh curved surface S7 and the eighth curved surface S8 are both planar. In the illustrated embodiment, the fourth lens L4 is a protective glass. It should be understood that the fourth lens L4 can be omitted.

The first lens L1 has a ratio of refractive index to Abbe number of 1.5/64. The first curved surface S1 of the first lens L1 is a convex surface facing the image side, the radius of curvature of which is −37 mm. The second curved surface S2 is a convex surface facing the object side, the radius of curvature of which is 400 mm. The first lens L1 has a central thickness d1 (i.e. a thickness of the first lens L1 on an optical axis) of 7 mm. The parameters above of the first lens L1 has a tolerance range of 5%, i.e. those parameters can vary within a range of ±5%.

The second lens L2 has a ratio of refractive index to Abbe number of 1.67/32. The third curved surface S3 of the second lens L2 is a convex surface facing the image side, the radius of curvature of which is −130 mm. The fourth curved surface S4 is a convex surface facing the image side, the radius of curvature of which is −60 mm. The second lens L2 has a central thickness d2 of 5 mm. The parameters above of the second lens L2 has a tolerance range of 5%.

The third lens L3 has a ratio of refractive index to Abbe number of 1.67/32. The fifth curved surface S5 of the third lens L3 is a convex surface facing the object side, the radius of curvature of which is 360 mm. The sixth curved surface S6 is a convex surface facing the image side, the radius of curvature of which is −68 mm. The third lens L3 has a central thickness d3 of 13 mm. The parameters above of the third lens L3 has a tolerance range of 5%.

The fourth lens L4 has a ratio of refractive index to Abbe number of 1.5/64. The curvature radii of the seventh curved surface S7 and the eighth curved surface S8 are ∞. The fourth lens L4 has a central thickness d4 of 3 mm. The parameters above of the fourth lens L4 has a tolerance range of 5%.

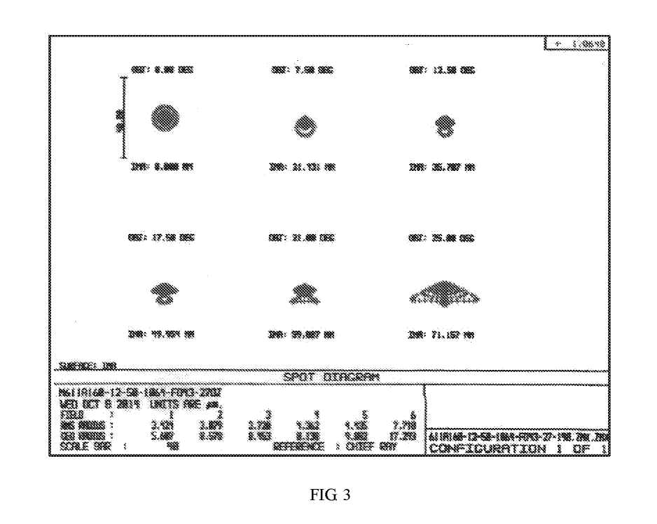

By merits of the foregoing design, the lens module 50 has the following optics parameters: a focal length is 160 mm, an entrance pupil diameter is 12 mm, a field of view is 50°, and an operating wavelength is 1060 nm. The lens module 50 enables the 3D printer 100 to process a workpiece with a size as follows: when the workpiece is a cylinder, it has a volume of V=Φ*L (where L is the length of the part processed), where the maximum of diameter Φ can be 0.14 m; when a cross-section of the workpiece is a rectangular, the workpiece has a volume of V=S*L, where the maximum of area S can be 0.1*0.1 m². The experimental test results of the lens module 50 are as shown in FIGS. 3 to 6.

FIG. 3 is a graphic diagram showing aberration of the lens module 50, where DBJ represents a viewing angle, in a unit of degree; IMA represents an imaging diameter of the image surface, in a unit of millimeter. The scale length of 40 mm is shown in FIG. 3. It can be seen that according to the astigmatism spot shown of FIG. 3 the astigmatism range of the focal spot of the lens module 50 is small, which has reached the ideal resolution, and the geometry astigmatism circle of the whole field of view is no larger than 8microns.

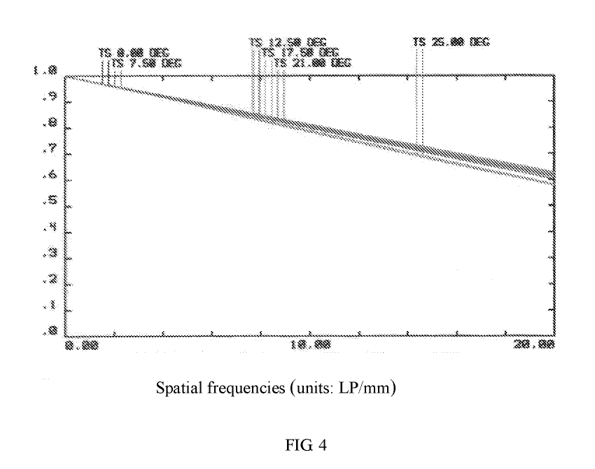

FIG. 4 is a graphic diagram showing modulation transfer function M.T.F of the lens module 50, where a abscissa represents a resolution, in a unit of line pairs per millimeter; TS represents the field of view, in a unit of degree. It can be seen from FIG. 4 that when the resolution is 20 line pairs per millimeter, MTF is also larger than 0.6, which implies that the resolution has reached 0.01 mm, and it is rather ideal.

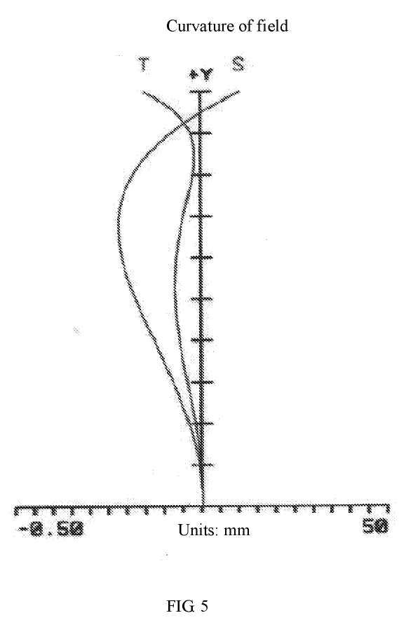

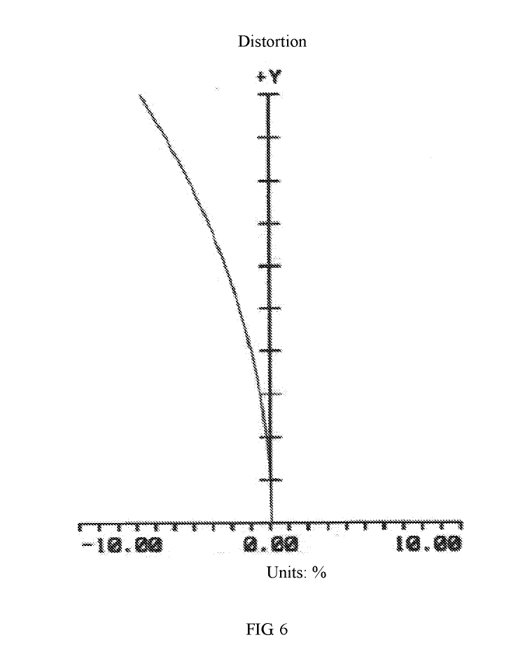

FIG. 5 is a graphic diagram showing astigmatism of the lens module 50 according to the embodiment of FIG. 1. An ordinate +Y of FIG. 5 represents the size of the field of view, and the unit of the abscissa is millimeter. FIG. 6 is a graphic diagram showing distortion of the lens module 50 according to the embodiment of FIG. 1. The ordinate +Y of FIG. 6 represents the size of the field of view, and the unit of the abscissa is percentage. It does not matter what the astigmatism or the distortion is rather ideal from FIGS. 5 to 6.

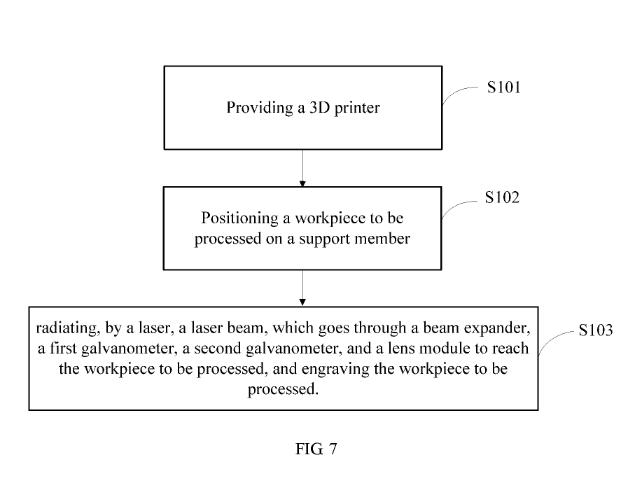

Referring to FIGS. 1 to 7 again, a printing method of the 3D printer 100 above includes:

In step S101, the above 3D printer 100 is provided;

In step S102, the workpiece 200 to be processed is positioned on the support member 70; and

In step S103, the laser 10 radiates a laser beam, which goes through a beam expander 20, a first galvanometer 30, a second galvanometer 40, and a lens module 50 to reach the workpiece 200 to be processed, and the laser beam engraves the workpiece 200 to be processed. Specifically, the laser beam melts or vaporizes a portion of the material of the workpiece 200 to be processed, so as to obtain the workpiece with a particular shape. During printing, the first galvanometer 30 and the second galvanometer 40 rotate to deflect the laser beam, the support member 70 drives the workpiece 200 to be processed to move to cooperate with deflecting of the laser beam, so as to achieve an overall engraving of the workpiece 200 to be processed.

Due to the arrangement and parameter design of the first lens to the fourth lens of the lens module 50, the 3D printer 100 exhibits high machining accuracy, thus it can be used to process the part that requires fine machining, and the application range thereof is expanded. In addition, by means of engraving, the 3D printer 100 can also engrave the part of the non-crushable raw materials (such as diamond, jade, crystal, precious metal and so on), such that the application range of the 3D printer 100 is further expanded. The engraving process provided by the lens module 50 cooperating with the 3D printer 100 enable the engraving accuracy of the 3D printer 100 to reach the silk grade (i.e. about 0.01 mm), the surface finish of the processed part is so fine that can be applied without additional machining. Furthermore, the 3D printer 100 can not only process solid part but also process part with cavity. At the same time, the lens module 50 employs four lenses only, which greatly simplifies the variety of optical materials.

It should be understood that when the size of the workpiece 200 to be processed varies, the lens module 50 having different focal lengths can be used for printing. It should be understood that the orienting bracket 60 can be omitted, as long as the support member 70 supports the workpiece 200 to be processed and makes it stationary.

The foregoing implementations are merely specific embodiments of the present disclosure, but are not intended to limit the protection scope of the present disclosure. It should be noted that any variation or replacement readily figured out by persons skilled in the art within the technical scope disclosed in the present disclosure shall all fall within the protection scope of the present disclosure. Therefore, the protection scope of the present disclosure shall be subject to the protection scope of the claims.

What is claimed is:

1. A lens module, comprising a first lens, a second lens, and a third lens, which are sequentially and coaxially arranged along a transmission direction of incident light, wherein the first lens is a biconcave lens, the second lens is a meniscus lens, and the third lens is a biconvex lens, the first lens has a first curved surface and a second curved surface, the second lens has a third curved surface and a fourth curved surface, the third lens has a fifth curved surface and a sixth curved surface, the first curved surface to the sixth curved surface are sequentially arranged along the transmission of the incident light, and the curvature radii of the first curved surface to the sixth curved surface are −37±5%, 400±5%, −130±5%, −60±5%, 360±5%, and −68±5%, respectively in a unit of millimeter.

2. The lens module of claim 1, wherein central thicknesses of the first lens to the third lens are 7±5%, 5±5%, and 13±5%, respectively in a unit of millimeter.

3. The lens module of claim 1, wherein the first lens has a ratio of refractive index to Abbe number of (1.5/64)±5%, the second lens has a ratio of refractive index to Abbe number of (1.67/32)±5%, and the third lens has a ratio of refractive index to Abbe number of (1.67/32)±5%.

4. The lens module of claim 1, further comprising a fourth lens disposed behind the third lens along the transmission direction of the incident light, wherein the fourth lens is a planar lens.

5. The lens module of claim 1, wherein the fourth lens is a protective glass, which has a central thickness of 3±5% mm, and a ratio of refractive index to Abbe number of (1.5/64) ±5%.

6. The lens module of claim 1, wherein the lens module has a focal length of 160 mm, an entrance pupil diameter of 12 mm, and an operating wavelength of 1060 nm.

7. A 3D printer, comprising a laser, a beam expander, a first galvanometer, a second galvanometer, and a lens module of claim 1, which are sequentially arranged along a transmission direction of incident light, wherein the laser, the beam expander, and the first galvanometer are collinearly arranged, the second galvanometer is parallel with the first galvanometer, wherein the 3D printer further comprises an orienting bracket located adjacent to the lens module, and a support member slidably mounted on the orienting bracket, the second galvanometer, the lens module, and the support member are sequentially and collinearly arranged.

8. A 3D printing method, comprising the following steps of:
providing a 3D printer of claim 7;
positioning a workpiece to be processed on a support member of the 3D printer; and
radiating, by a laser, a laser beam, which goes through a beam expander, a first galvanometer, a second galvanometer, and a lens module to reach the workpiece to be processed, and engraving the workpiece to be processed.

9. The 3D printing method of claim 8, wherein during engraving of the workpiece to be processed by the laser beam, the first galvanometer and the second galvanometer rotate to deflect the laser beam, the support member drives the workpiece to be processed to move to cooperate with deflecting of the laser beam, so as to achieve an overall engraving of the workpiece to be processed.
